(19) United States
(12) Patent Application Publication
(10) Pub. No.: US 2008/0182718 A1
(43) Pub. Date: Jul. 31, 2008

(54) CONTROL DEVICE FOR AUTOMATIC TRANSMISSION AND CONTROL METHOD FOR AUTOMATIC TRANSMISSION

(75) Inventors: Daisuke Ido, Nagoya-shi (JP); Yoshiki Itou, Nukata-gun (JP)

Correspondence Address: SUGHRUE MION, PLLC, 2100 PENNSYLVANIA AVENUE, N.W., SUITE 800, WASHINGTON, DC, 20037, US

(73) Assignee: c/o TOYOTA JIDOSHA KABUSHIKI KAISHA, Toyota-shi (JP)

(21) Appl. No.: 12/022,460

(22) Filed: Jan. 30, 2008

(30) Foreign Application Priority Data
Jan. 31, 2007 (JP) 2007-020467

(51) Int. Cl. F16H 61/18

(52) U.S. Cl. 477/125

(57) ABSTRACT

A control of a control device and control method of an automatic transmission provided on a vehicle to shift the automatic transmission between forward, reverse and neutral gears, includes the steps of: detecting a shift request from one of the forward or reverse gear to the other of the forward or reverse gear; acquiring an operating condition relating to a shift from one of the forward or reverse gear to the other of the forward or reverse gear; acquiring a running condition from a vehicle speed sensor of the vehicle; determining whether to permit a gear shift based on the operating condition and the running condition when a shift request is detected; and executing a control to shift from one of the forward or reverse gear to the other of the forward or reverse gear when the shift determination device determines that a gear shift is permissible.

### INCORPORATION BY REFERENCE

The disclosure of Japanese Patent Application No. 2007-020467 filed on Jan. 31, 2007, including the specification, drawings and abstract is incorporated herein by reference in its entirety.

### BACKGROUND OF THE INVENTION

1. Field of the Invention

The present invention relates to a control device for an automatic transmission and a control method for an automatic transmission, and more particularly to a control device for an automatic transmission and a control method for an automatic transmission for shifting a vehicle between forward and reverse modes.

2. Description of the Related Art

In a conventional control device for an automatic transmission for shifting a vehicle between forward and reverse modes, when the automatic transmission is shifted to a reverse gear range intentionally or accidentally by the user while the vehicle is moving forward at a speed equal to or higher than a predetermined speed, the control function to shift the gears of the automatic transmission is not executed because a shift shock may occur or excessive force may be exerted on the automatic transmission to that would damage to the automatic transmission (for example, see Japanese Patent Application Publication No. 2004-60804 (JP-A-2004-60804)).

The conventional control device for an automatic transmission described in Japanese Patent Application Publication No. 2004-60804 (JP-A-2004-60804) compares the vehicle speed and the permissible speed when the driver operates a range select switch to make a request for a shift from the forward gear range to the reverse gear range. Then, when the comparison indicates that the vehicle speed is higher than the permissible speed, the control device does not perform the control function to shift the gears according to the shift request and maintains the forward gear range.

In the conventional control device for an automatic transmission, however, the determination on whether to perform the shifting control according to a shift request is made based on the vehicle speed and the permissible speed, and a request for a shift from the forward gear range to the reverse gear range is rejected without exception when the vehicle is at a speed higher than the permissible speed.

Therefore, there is a problem that even if the driver intentionally performs a range shift operation when the vehicle is at a speed higher than the permissible speed, the shift request is rejected and the operation intended by the driver cannot be carried out.

### SUMMARY OF THE INVENTION

the present invention provides a control device for an automatic transmission and a control method for an automatic transmission which can reflect (i.e. respond to) the intention of the driver to determine whether a forward-reverse shifting request is valid properly to protect the automatic transmission and improve the ease of operation for the driver.

According to one aspect of the present invention, there is provided a control device for an automatic transmission, including: a shift request detection means for detecting a shift request from one of the forward or reverse gear to the other of the forward or reverse gear; an operating condition acquisition device for acquiring an operating condition relating to a shift from one of the forward or reverse gear to the other of the forward or reverse gear; a running condition acquisition device for acquiring a running condition from a vehicle speed sensor of the vehicle; a shift determination device for determining whether to permit a gear shift based on the operating condition and the running condition when a shift request is detected by the shift request detection device; and a controller that executes a control to shift from one of the forward or reverse gear to the other of the forward or reverse gear when the shift determination device determines that a gear shift is permissible.

According to another aspect of the present invention, there is provided a control method for an automatic transmission for controlling an automatic transmission provided on a vehicle to shift the automatic transmission between forward, reverse and neutral gears. The control method includes: detecting a shift request from one of the forward or reverse gear to the other of the forward or reverse gear; acquiring an operating condition relating to a shift from one of the forward or reverse gear to the other of the forward or reverse gear; acquiring a running condition from a vehicle speed sensor; determining whether a gear shift is permissible based on the operating condition and the running condition when the shift request is detected; and executing a control to shift from one of the forward or reverse gear to the other of the forward or reverse gear when it is determined that a gear shift is permissible.

According to the above control device and control method for an automatic transmission, it is determined whether to permit shifting of the automatic transmission from one of forward or reverse gear to the other based on the running condition of the vehicle and the operating condition of the vehicle. Therefore, quick shifting reflecting the intention of the driver of the vehicle 1 can be accomplished, and damage to the automatic transmission caused by unusual forward-reverse shifting is prevented.

### BRIEF DESCRIPTION OF THE DRAWINGS

The foregoing and further features and advantages of the invention will be better understood by reading the following detailed description of preferred embodiments of the invention, when considered in connection with the accompanying drawings, in which:

FIG. 1 is a schematic view of a vehicle provided with a control device for an automatic transmission according to one embodiment of the present invention;

FIG. 2 is a schematic view illustrating an example of the steering wheel of the vehicle provided with a control device for an automatic transmission according to one embodiment of the present invention;

FIG. 3 is a schematic view illustrating an example of the positional relation between the positions and gear ranges of the shift lever of the vehicle provided with a control device for an automatic transmission according to one embodiment of the present invention;

FIG. 4 is a schematic view that depicts the correspondence between the gear ranges of the vehicle provided with the control device for an automatic transmission according to one embodiment of the present invention and the gears to which the automatic transmission 5 is allowed to be shifted;

FIG. 5 is a schematic view of a first map of the vehicle provided with the control device for an automatic transmission according to one embodiment of the present invention;

FIG. 6 is a schematic view of a second map of the vehicle provided with the control device for an automatic transmission according to one embodiment of the present invention;

FIG. 7 is a schematic view of a third map of the vehicle provided with the control device for an automatic transmission according to one embodiment of the present invention;

FIG. 8 is a schematic view of a fourth map of the vehicle provided with the control device for an automatic transmission according to one embodiment of the present invention;

FIG. 9 is a schematic view of a coincidence degree map of the vehicle provided with the control device for an automatic transmission according to one embodiment of the present invention;

FIG. 10 is a schematic view of a execution correspondence map of the vehicle provided with the control device for an automatic transmission according to one embodiment of the present invention;

FIG. 11 is a flowchart for explaining a forward-reverse shifting control function by the control device for an automatic transmission according to one embodiment of the present invention;

FIG. 12 is a flowchart for explaining a warning determination procedure in the control device for an automatic transmission according to one embodiment of the present invention;

FIG. 13 is a flowchart for explaining an intention level calculation procedure in the control device for an automatic transmission according to one embodiment of the present invention;

FIG. 14 is a flowchart for explaining a coincidence degree calculation procedure in the control device for an automatic transmission according to one embodiment of the present invention; and

FIG. 15 is a flowchart for explaining a shift control procedure in the control device for an automatic transmission according to one embodiment of the present invention.

### DETAILED DESCRIPTION OF THE PREFERRED EMBODIMENTS

In the following description and the accompanying drawings, the present invention will be described in greater detail with reference to the example embodiments.

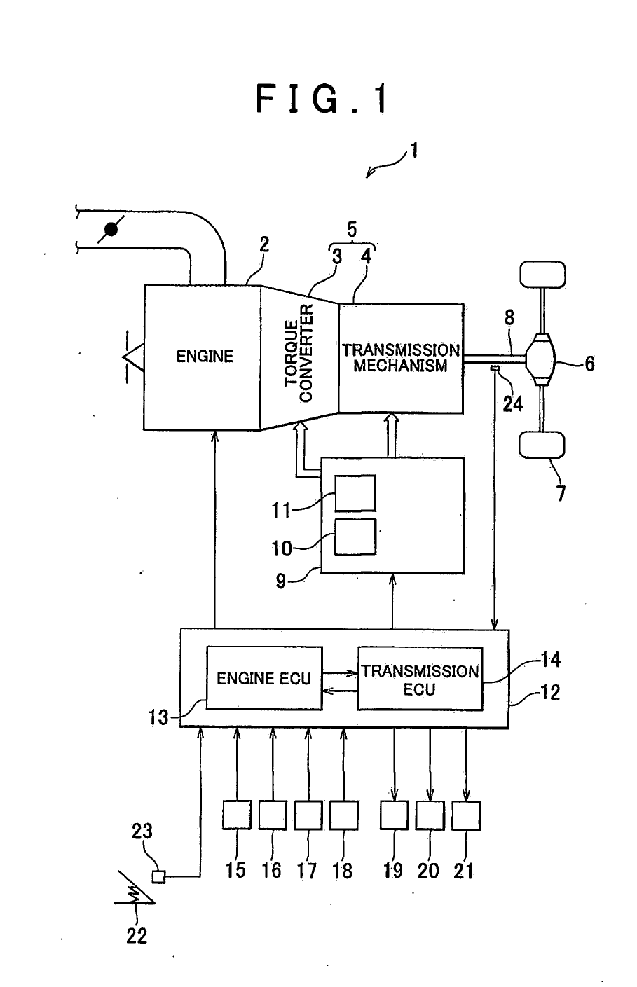

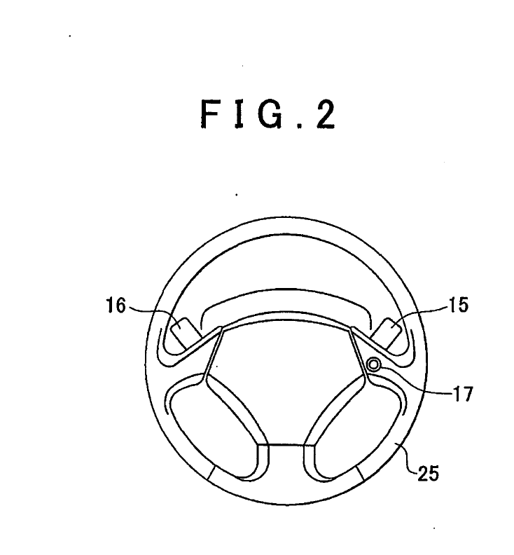

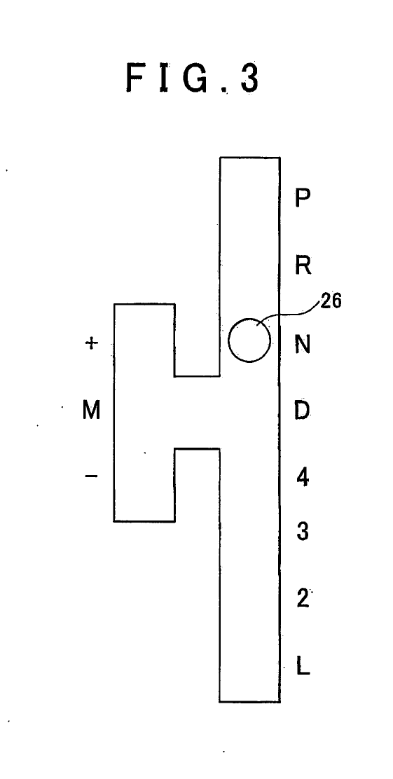

FIG. 1 is a schematic diagram of a vehicle provided with an automatic transmission control device according to one embodiment of the present invention. FIG. 2 is a schematic view of the steering wheel of the vehicle provided with a control device for an automatic transmission according to one embodiment of the present invention. FIG. 3 is a schematic view of the positional relation between the positions and ranges of the shift lever of the vehicle provided with a control device for an automatic transmission according to one embodiment of the present invention.

A vehicle 1 has an engine 2 constituting an internal combustion engine; a torque converter 3 that amplifies the rotary torque output from the engine 2; a transmission mechanism 4 that changes the rotational speed of the output shaft of the torque converter 3 and that transmits the rotation thereof; and a propeller shaft 8, connected to the output shaft of the transmission mechanism 4, that transmits the rotary torque from the transmission mechanism 4 to the rear wheels 7 via a differential gear 6. The torque converter 3 and the transmission mechanism 4 constitute the automatic transmission 5.

Although the automatic transmission control device according to the present invention is described in the context of a rear-wheel drive vehicle 1, the present invention is not limited thereto.

The vehicle 1 also has a hydraulic control circuit 9 for controlling the torque amplification ratio of the torque converter 3 and the gear ratio of the transmission mechanism 4 by hydraulic pressure. The hydraulic control circuit 9 has a plurality of shift valves 10 and a manual valve 11 for switching the route through which hydraulic pressure is supplied to the shift valves 10 to shift the automatic transmission 5.

The vehicle 1 also has an accelerator operation sensor 23 that outputs an accelerator operation amount signal, which is an output voltage proportional to the amount by which an accelerator pedal 22 is depressed. The accelerator operation sensor 23 includes an electronic position sensor using a Hall element, for example, and measures the angle of a magnetic field, which changes with the stroke amount by which the accelerator pedal 22 is depressed. The angle of the magnetic field is then output as the accelerator operation amount signal.

The vehicle 1 also includes an electronic control device 12. The electronic control device 12 has an engine ECU 13 that controls the engine 2, and a transmission ECU 14 that controls the automatic transmission 5.

The engine ECU 13 includes a Central Processing Unit (CPU), a Random Access Memory (RAM), a Read Only Memory (ROM), and an input-output interface (which are not shown), and outputs an engine control signal to the engine 2 such that the engine 2 is controlled according to the displacement of the accelerator pedal 22.

The engine ECU 13 controls the engine 2 based on a throttle opening control signal that controls the throttle opening of the engine 2, and receives a signal that indicates the engine speed Ne, which corresponds to the rotational speed of the input shaft of the torque converter 3.

The transmission ECU 14 has a CPU, a RAM, a ROM and an input-output interface (which are not shown). The ROM stores a map that represents a shift diagram based on the vehicle speed and the throttle opening, a program for executing a shift control and so on.

The transmission ECU 14 constitutes a control device, an operating condition acquisition means, a running condition acquisition means, a shift request detection means, a shift determination means, a control means, and a limit speed determination means according to the present invention as described later.

The transmission ECU 14 calculates the throttle opening of the engine 2 based on an accelerator operation signal that indicates the accelerator operation amount, and transmits a throttle opening signal indicating the calculated throttle opening to the engine ECU 13. Also, the transmission ECU 14 receives an engine speed signal that indicates the engine speed Ne from the engine ECU 13. The vehicle 1 has a vehicle speed sensor 24 for measuring the vehicle speed based on the rotational speed of the propeller shaft 8, and the transmission ECU 14 receives a vehicle speed signal that indicates the vehicle speed measured by the vehicle speed sensor 24.

The vehicle 1 also has first and second paddles 15 and 16 used to shift the gears of the automatic transmission 5, and a forward-reverse selector switch 17 used to shift the gears of the automatic transmission 5 from one of forward or reverse gear to the other of forward or reverse gear on the steering wheel 25.

The forward-reverse selector switch 17 is not necessarily provided on the steering wheel 25. For example, the forward-reverse selector switch 17 may be located in a console box in an instrument panel (not shown) in the vicinity of the driver's seat. The forward-reverse selector switch 17 may be formed as a lever, and the lever may be located on the steering column (not shown).

The vehicle 1 also has a shift lever 26, and the shift lever 26 may be positioned in an L position representing a low range, 2 to 4 positions representing second to fourth ranges, a D position representing a drive gear range, an N position representing a neutral range, an R position representing a reverse gear range, and a P position representing a parking range, which are arrange from the side of the rear of the vehicle 1 toward the side of the front thereof.

The low range, the second to fourth ranges and the drive range are forward gear ranges.

The shift lever 26 may also be positioned in an M position that represents a manual gear position used to manually shift the gears of the automatic transmission 5, a plus position (+ position) for upshifting and a minus position (− position for downshifting. The M position is located on one side of the D position. When the shift lever 26 is shifted laterally from the D position, it is held in the M position by a spring (not shown).

The first paddle 15 inputs a signal for upshifting the automatic transmission 5 to the transmission ECU 14 when it is pulled by the driver. The second paddle 16 inputs a signal for downshifting the automatic transmission 5 to the transmission ECU 14 when it is pulled by the driver.

The signal outputted from the first paddle 15, the second paddle 16 and the forward-reverse selector switch 17 to the transmission ECU 14 is valid only when the shift lever 26 is in the M position.

While a case in which the shift lever 26 takes the M position is described in the above explanation, the present invention is not limited thereto. The shift lever 26 may take any of the L position, the 2 to 4 positions, the D position, the N position, the R position and the P position.

In this case, the operation of the first paddle 15 and the second paddle 16 is effective only when the shift lever 26 is in the D position. For example, when the first paddle 15 or the second paddle 16 is operated by the driver when the shift lever 26 is in the D position, the transmission ECU 14 is switched from an automatic shift mode to a manual operation mode. Also, the operation of the forward-reverse selector switch 17 is effective only when the transmission ECU 14 is in the manual operation mode.

The transmission ECU 14 cancels the manual operation mode and switches to the automatic shift mode when the gear designated by manual operation and the gear according to the shift diagram coincide with each other for a predetermined time period and the first paddle 15 and the second paddle 16 are not operated for a predetermined time period.

While a case in which the vehicle 1 has the first paddle 15, the second paddle 16 and the shift lever 26 is described in the above explanation, the present invention is not limited thereto. The shift lever 26 may be omitted from the vehicle 1.

In this case, the first paddle 15 and the second paddle 16 are configured to be used for shifting between the low range, second to fourth gear ranges, D range and N range, and the forward-reverse selector switch 17 is configured to be used for shifting to the R range.

Alternatively, the vehicle 1 may have a switch (not shown) that switches between a mode in which manual operation is effective and a mode in which manual operation is ineffective. In this case, when manual operation is set to be effective, the gears of the automatic transmission 5 can be directly shifted with the first paddle 15 and the second paddle 16. When manual operation is set to be ineffective, the transmission ECU 14 is switched to the automatic shift mode and a shift between the low range, second to fourth gear ranges, D range and N range can be made with the first paddle 15 and the second paddle 16.

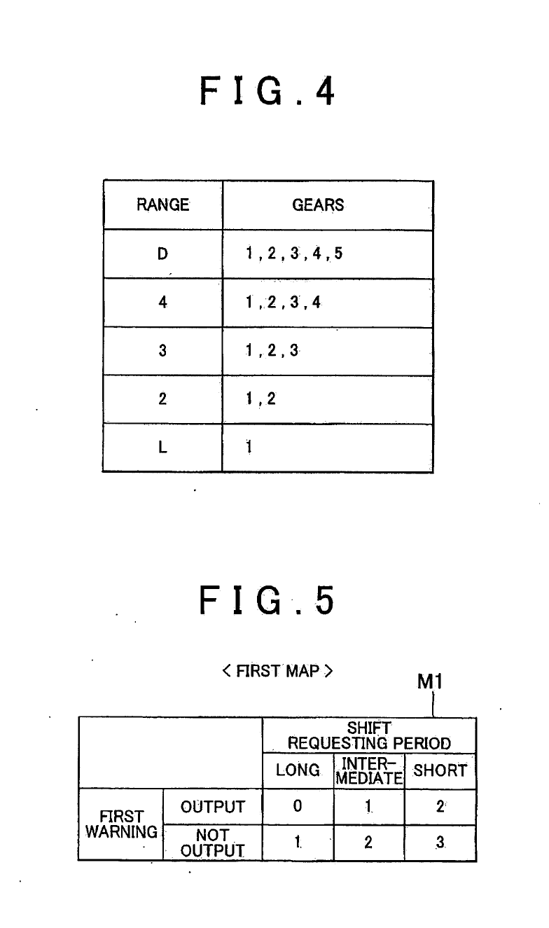

When a range is designated by the driver, the transmission ECU 14 shifts the gears of the automatic transmission 5 via the hydraulic control circuit 9 based on the designated range, the vehicle speed, the throttle opening and the map that represents a shift diagram. FIG. 4 is a is a schematic view of the correspondence between the ranges of the vehicle provided with the control device for an automatic transmission according to one embodiment of the present invention and the gears to which the automatic transmission 5 is allowed to be shifted. For example, in the D range, the automatic transmission 5 may be shifted between the first to fifth gears.

When the N range is selected by the driver, the transmission ECU 14 controls the automatic transmission 5 so that torque is not transmitted from the input shaft of the automatic transmission 5 to the output shaft thereof.

When the P range is selected by the driver, the transmission ECU 14 controls the automatic transmission 5 so that torque is not transmitted from the input shaft of the automatic transmission 5 to the output shaft thereof, and engages a parking pole (not shown) with a parking gear mounted on the output shaft of the automatic transmission 5 to arrest the output shaft of the automatic transmission 5.

The vehicle 1 also has a brake depression force sensor 18 for measuring the depression force applied to the brake pedal (not shown). The brake depression force sensor 18 measures the change in master cylinder pressure or operation stroke which changes depending on the operating depression force applied to the brake pedal by the driver, and outputs an electric signal proportional to the measured depression force to the transmission ECU 14 as a brake depression force signal.

Also, the transmission ECU 14 calculates the longitudinal acceleration of the vehicle 1 based on the change in vehicle speed input from the vehicle speed sensor 24.

The transmission ECU 14 processes the inputted accelerator operation signal and vehicle speed signal based on the data and program stored in the ROM, and controls the gears of the transmission mechanism 4 and the line pressure through the hydraulic control circuit 9.

The transmission mechanism 4 is includes a plurality of planetary gears and friction elements for imposing conditions on the rotation of the planetary gears. The hydraulic control circuit 9 selectively engages and disengages the friction elements by hydraulic oil pressure derived from the line pressure, and changes the ratio of the rotational speeds of the input shaft and the output shaft of the transmission mechanism 4 to achieve a speed change between the input shaft and the output shaft of the transmission mechanism 4. The friction elements include a clutch element, a brake element, a one-way clutch element, and so on.

The torque converter 3 is located between the engine 2 and the transmission mechanism 4, and includes a fluid coupling mechanism (not shown), and a lockup mechanism (not shown) for improving the transmission efficiency of the power from the engine 2 to the transmission mechanism 4.

The lockup mechanism has an input shaft that is mechanically coupled to the output shaft of the torque converter 3 by fluid hydraulic oil to improve the transmission efficiency of the power from the engine 2 to the transmission mechanism 4 when the vehicle 1 is running at a high speed. The lockup mechanism may couple the input shaft and the output shaft of the torque converter 3 in such a manner that the input shaft and the output shaft slip with a predetermined slip rate so that the torque converter 3 may provide flexible lockup therebetween.

A configuration in which the control device for an automatic transmission according to one embodiment of the present invention determines whether to permit shifting of the automatic transmission 5 from one of forward or reverse gear to the other of forward or reverse gear based on the running conditions of the vehicle 1 and the operating conditions of the vehicle 1 is described below.

The forward-reverse selector switch 17 outputs a shift request signal that indicates a request for shifting between forward and reverse modes when pressed by the driver.

The transmission ECU 14 detects the shift request signal output from the forward-reverse selector switch 17. That is, the transmission ECU 14 constitutes a shift request detection means.

Also, the transmission ECU 14 receives a vehicle speed signal from the vehicle speed sensor 24. Here, if it is determined that the vehicle speed has decreased to a speed below the lowest speed that the vehicle speed sensor 24 can detect (which is hereinafter referred to as “minimum detectable speed”), the transmission ECU 14 measures the time period after the vehicle speed fell below the minimum detectable speed. Therefore, the transmission ECU 14 constitutes a limit speed determination means for determining whether the vehicle speed has fallen below the minimum detectable speed.

When the transmission ECU 14 detects a shift request signal that indicates a request for shifting between forward and reverse modes, it refers the time period from the time when the vehicle speed fell below the minimum detectable speed to the present time and determines, based on a brake depression force signal input from the brake depression force sensor 18, whether a shift shock will occur when the vehicle 1 is shifted between forward and reverse modes.

For example, the transmission ECU 14 determines that the vehicle has not come to a complete stop and a shift shock will occur as a result of shifting between the forward and reverse modes if the time period from the time when the vehicle speed fell below the minimum detectable speed to the present time is within one second when a brake depression force signal indicating that the brake pedal is depressed by the driver is input from the brake depression force sensor 18.

Also, the transmission ECU 14 determines that the vehicle has not come to a complete stop and a shift shock will occur in shifting between forward and reverse modes if the brake depression force signal input from the brake depression force sensor 18 indicates that the brake pedal is not being depressed by the driver and the time period from the time when the vehicle speed fell below the minimum detectable speed to the present time is within five seconds.

If the transmission ECU 14 determines that a shift shock will occur as a result of shifting between forward and reverse modes, it outputs a first warning signal that indicates a shift shock will occur.

The first warning signal is sent out to a monitor 19, a buzzer 20 having a loudspeaker (not shown) on the front panel (not shown) of the vehicle 1 or a vibration element 21 attached to the steering wheel 25, for example, and the warning indicated by the first warning signal is displayed on the monitor 19, the buzzer 20 outputs sound, or the vibration elemental vibrates the steering wheel 25. Each of the monitor 19, the buzzer 20 and the vibration element 21 constitutes a warning device.

When the transmission ECU 14 outputs a first warning signal, it stores data indicating that a first warning signal was output in a memory composed of a RAM. The transmission ECU 14 also measures the shift requesting period, the time period for which the forward-reverse selector switch 17 is operated, with a timer.

Also, the transmission ECU 44 has first to fourth maps M1 to M4 in which a driving operation and the levels of the driver's intention to execute the shift between forward and reverse modes are associated with each other in a memory including a ROM or the like.

FIG. 5 is a schematic view of a first map of the vehicle provided with the control device for an automatic transmission according to one embodiment of the present invention. In the first map M1, an operating condition of the vehicle 1 is represented by the time period for which the forward-reverse selector switch 17 was operated by the driver. The transmission ECU 14 calculates the intention level of the driver based on the shift requesting period measured by the timer and the first map M1 when the forward-reverse selector switch 17 is operated by the driver.

In addition, the intention level of the driver is also based on whether the first warning signal has been output in the first map M1. Therefore, when the transmission ECU 14 calculates the intention level of the driver based on the first map M1, it refers to the memory and acquires data from the memory on whether the first warning signal has been output.

The shift requesting period input from the forward-reverse selector switch 17 is classified into one of three time period categories designated in descending order of length of time as: “long,” “intermediate” and “short.” The transmission ECU 14 determines to which of the categories (“short,” “intermediate” and “long”) the operating period of the forward-reverse selector switch 17 measured by the timer belongs. For example, the transmission ECU 14 classifies the shift requesting period input from the forward-reverse selector switch 17 into “short” if it is less than one second, into “intermediate” if it is longer than one second and shorter than four seconds, and into “long” if it is longer than four seconds.

In this embodiment, a smaller value of the intention level represents a higher intention level of the driver in the first map M1, and the longer the shift requesting period measured by the timer is, the intention level is determined to be higher. In addition, the intention level is determined to be higher when the first warning signal has been output than when the first warning signal has not been output.

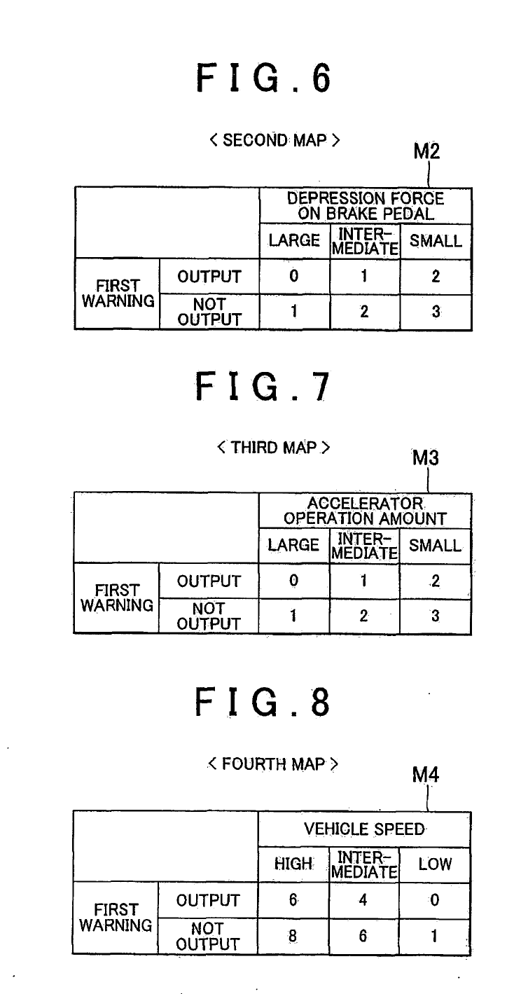

FIG. 6 is a schematic view of a second map of the vehicle provided with the control device for an automatic transmission according to one embodiment of the present invention. In the second map M2, an operating condition of the vehicle 1 is represented by the depression force applied to the brake pedal, and the transmission ECU 14 receives a signal that indicates the depression force applied to the brake pedal from the brake depression force sensor 18 and calculates the intention level of the driver based on the second map M2 when the forward-reverse selector switch 17 is operated by the driver.

Also in the second map M2, the intention level of the driver is also based on whether the first warning signal has been output. Therefore, when the transmission ECU 14 calculates the intention level of the driver based on the second map M2, it acquires data on whether the first warning signal has been output stored in the memory.

In this embodiment, a smaller value of the intention level represents a higher intention level of the driver in the second map, and the greater the depression force applied to the brake pedal, the higher the intention level is determined to be. In addition, the intention level is determined to be higher when the first warning signal has been output than when the first warning signal has not been output.

FIG. 7 is a schematic view of a third map of the vehicle provided with the control device for an automatic transmission according to one embodiment of the present invention. In the third map M3, an operating condition of the vehicle 1 is represented by the accelerator operation, and the transmission ECU 14 receives an accelerator operation signal input from the accelerator operation sensor 23 and calculates the intention level of the driver based on the third map M3 when the forward-reverse selector switch 17 is operated by the driver.

Also in the in the third map M3, the intention level of the driver is also based on whether the first warning signal has been output. Therefore, when the transmission ECU 14 calculates the intention level of the driver based on the third map M3, it acquires data on whether the first warning signal has been output stored in the memory.

In this embodiment, a smaller value of the intention level represents a higher intention level of the driver in the third map M3, and the smaller the accelerator operation is, the higher the intention level, is determined to be. In addition, the intention level is determined to be higher when the first warning signal has been output than when the first warning signal has not been output.

FIG. 8 is a schematic view of a fourth map of the vehicle provided with the control device for an automatic transmission according to one embodiment of the present invention. In the fourth map M4, an operating condition of the vehicle 1 is represented by the vehicle speed of the vehicle 1, and the transmission ECU 14 receives a vehicle speed signal from the vehicle speed sensor 24 and calculates the intention level of the driver based on the fourth map M4 when the forward-reverse selector switch 17 is operated by the driver.

Also in the in the fourth map M4, the intention level of the driver is also based on whether the first warning signal has been output. Therefore, when the transmission ECU 14 calculates the intention level of the driver based on the fourth map M4, it acquires data on whether the first warning signal has been output stored in the memory.

In this embodiment, a smaller value of the intention level represents a higher intention level of the driver in the fourth map M, and the lower the vehicle speed is, the higher the intention level is determined to be. In addition, the intention level is determined to be higher when the first warning signal has been output than when the first warning signal has not been output

As described above, the transmission ECU 14 acquires operating conditions of the vehicle 1, the time period for which the forward-reverse selector switch 17 was being operated, the depression force on the brake pedal, the accelerator operation amount and the vehicle speed, to calculate the intention levels of the driver. That is, the transmission ECU 14 constitutes an operating condition acquisition means.

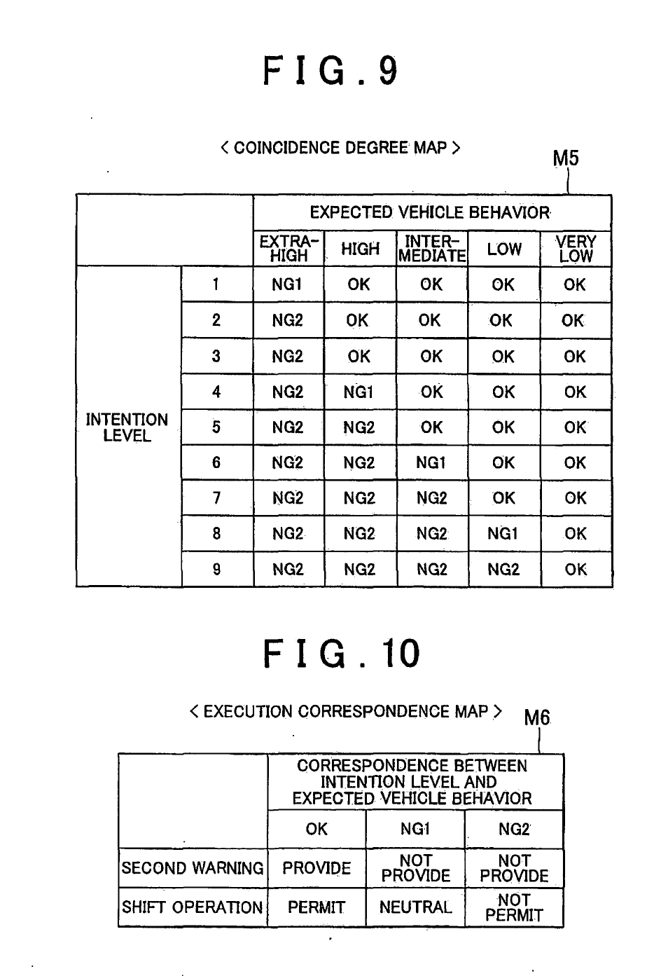

In addition, the transmission ECU 14 has a coincidence degree map M5 in which the running conditions of the vehicle 1 and the intention level of the driver are associated with the degree of coincidence therebetween in the memory. FIG. 9 is a view schematically illustrating a coincidence degree map of the vehicle provided with the control device for an automatic transmission according to one embodiment of the present invention.

The transmission ECU 14 obtains the total of the intention levels obtained based on the first map M1 to the fourth map M4 and calculates to which of nine standardized intention levels the intention level belongs. In the coincidence degree map M5, a smaller value of the intention level represents a higher intention level.

Here, the running conditions are represented by the vehicle speed and acceleration of the vehicle 1, and the transmission ECU 14 acquires the speed of the vehicle 1 input from the vehicle speed sensor 24 and the acceleration calculated from the change in the speed as the running conditions. Therefore, the transmission ECU 14 constitutes a running condition acquisition means.

The transmission ECU 14 calculates an expected vehicle behavior, which represents the degree of a shift shock which the vehicle 1 is expected to have when shifting between forward and reverse modes is actually carried out, based on the acquired running conditions. The transmission ECU 14 classifies the degree of the expected shift shock into categories by magnitude. The categories are designated in the descending order as: “extra-high,” “high,” “intermediate,” “low,” and “very low,” for example.

The transmission ECU 14 may have a map in which the vehicle speed and acceleration are associated with the expected vehicle behavior in the memory in advance and determine an expected vehicle behavior based on the vehicle speed and acceleration of the vehicle 1 achieved from the vehicle speed sensor 24 and the map.

The coincidence degree herein represents how much the intention level coincides with the running conditions of the vehicle 1 when the forward-reverse selector switch 17 is operated. For example, it is defined that when the expected vehicle behavior corresponding to the running conditions of the vehicle 1 is classified into “low” or “very low” and the intention level is high, there is a high degree of coincidence between the running conditions and the intention level.

In contrast, it is defined that when the expected vehicle behavior corresponding to the running conditions of the vehicle 1 is classified into “extra-high” or “high” and the intention level is low, there is a low degree of coincidence between the running conditions and the intention level.

In this embodiment, the coincidence degree is classified into three levels designated in descending order as: “OK,” “NG1” and “NG2.”

The transmission ECU 14 also has an execution correspondence map M6 in which the coincidence degree obtained from the coincidence degree map M5 is associated with whether to provide the driver with a warning and whether to execute the shift between forward and reverse mode in a memory including a ROM or the like. FIG. 10 is a view schematically illustrating an execution correspondence map M6 of the vehicle provided with the control device for an automatic transmission according to one embodiment of the present invention.

The transmission ECU 14 determines whether to control the warning device to provide a warning instruction to the driver and whether to execute a forward-reverse shifting control function based on the execution correspondence map M6. That is, the transmission ECU 14 constitutes a shift determination means that determines whether to permit the automatic transmission 5 to shift from one of the forward or reverse gear to the other of forward or reverse gear based on the operating conditions and the running conditions.

The transmission ECU 14 performs a gear shift control function on the automatic transmission 5 to shift the vehicle 1 between forward and reverse modes if the coincidence degree based on the execution correspondence map M6 is “OK.”

For example, when a request for a shift from forward to reverse mode is permitted when the vehicle 1 is at rest or traveling forward, the automatic transmission 5 is shifted from the current gear to gear for backward travel (reverse gear) by the hydraulic control circuit 9 and an actuator.

When a request for a shift from reveres to forward mode is permitted when the vehicle 1 is at rest or traveling backward, the automatic transmission 5 is shifted from reverse gear to first gear by the hydraulic control circuit 9 and an actuator.

Therefore, the transmission ECU 14 constitutes a control means for performing a control function to shift the automatic transmission 5 from one of the forward or reverse gear to the other of forward or reverse gear when a request for a shift from forward to reveres mode or from reveres to forward mode is permitted.

The transmission ECU 14 shifts the automatic transmission 5 to the gear for neutral (neutral gear) instead of performing a forward-reverse shifting control function if the degree of coincidence based on the execution correspondence map M6 is “NG1.”

The transmission ECU 14 does not perform any shift control function on the automatic transmission 5 and maintains the current gear if the degree of coincidence based on the execution correspondence map M6 is “NG2.”

The transmission ECU 14 may transmit a second warning signal, which indicates that the shifting between forward and reverse modes is not permitted, to the warning device if the degree of coincidence is “NG1” or “NG2.”

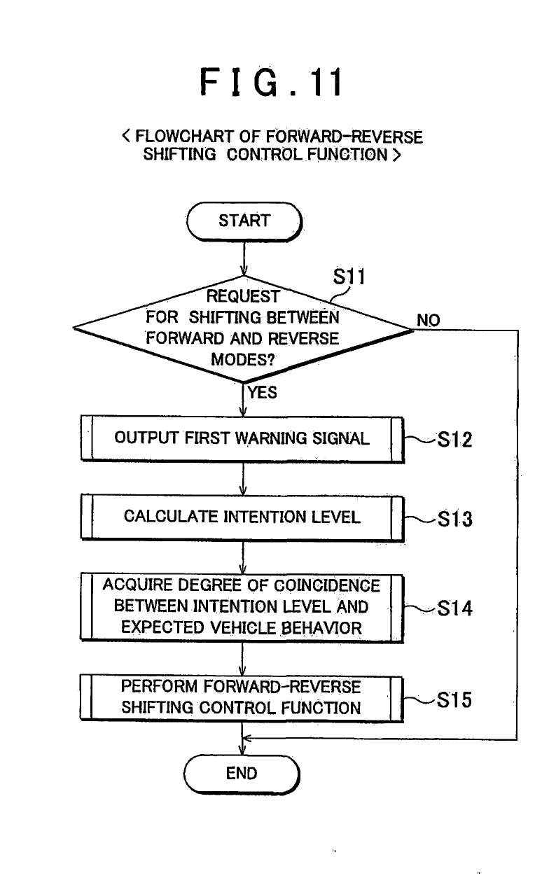

The operation of the control device for an automatic transmission according to one embodiment of the present invention is described below with reference to FIG. 11 to FIG. 15.

FIG. 11 is a flowchart that explains a forward-reverse shifting control function by the control device for an automatic transmission according-to one embodiment of the present invention. The following operation is performed at predetermined time intervals by a CPU constituting the transmission ECU 14 and implements a program that the CPU may process.

First, the transmission ECU 14 determines whether a shift request signal that indicates a request for a shift between forward and reverse modes is detected from the forward-reverse selector switch 17 (step S11).

If it is determined that no shift request signal is detected (No in step S11), the transmission ECU 14 terminates the operation. If it is determined that a shift request signal is detected (Yes in step S11), the process goes to step S12.

Next, the transmission ECU 14 determines, according to warning determination procedure, which is described later, whether to output the first warning signal. If it is determined that the first warning signal should be output, the transmission ECU 14 outputs the first warning signal (step S12). Here, the transmission ECU 14 stores information on whether the first warning signal was output in the memory, and the process goes to step S13.

The transmission ECU 14 then calculates the intention level corresponding to acquired operating conditions according to the intention level calculation procedure, which is described later (step S13).

Next, the transmission ECU 14 acquires the running conditions of the vehicle 1, and calculates the degree of coincidence between the intention level and the expected vehicle behavior according to the coincidence degree calculation procedure, which is described (step S14).

The transmission ECU 14 then performs a forward-reverse shifting control function corresponding to the calculated degree of coincidence on the automatic transmission 5 according to the shift control procedure, which is described later (step S15), and terminates the operation.

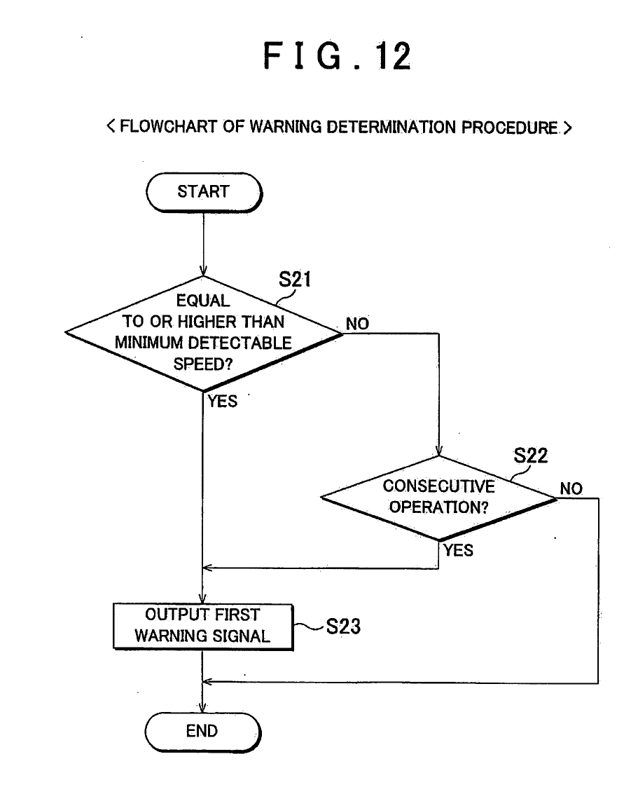

The transmission ECU 14 performs a warning determination procedure in step S12. FIG. 12 is a flowchart for explaining the warning determination procedure in the control device for an automatic transmission according to one embodiment of the present invention.

First, when a shift request signal that indicates a request to shift between the forward and reverse modes is detected, the transmission ECU 14 determines whether the vehicle speed is equal to or above the minimum detectable speed based on the vehicle speed signal from the vehicle speed sensor 24 (step S21).

If the transmission ECU 14 determines that the vehicle speed is equal to or above the minimum detectable speed, the process goes to step S23. If it is determined that the vehicle speed is below the minimum detectable speed, the process goes to step S22.

If it is determined that the vehicle speed is below the minimum detectable speed (No in step S21), the transmission ECU 14 determines whether the operation of the forward-reverse selector switch 17 is a consecutive operation (step S22). In this step, the transmission ECU 14 refers the timer that measures the time period from the time when the vehicle speed fell below the minimum detectable speed to the present time to calculate the time period from the time the vehicle speed fell below the minimum detectable speed to the time the forward-reverse selector switch 17 was operated. The transmission ECU 14 also determines whether the brake is operated based on the brake depression force signal input from the brake depression force sensor 18.

If the brake is not being operated and the time period from the time when the vehicle speed fell below the minimum detectable speed to the time when the forward-reverse selector switch 17 was operated is shorter than five seconds, the transmission ECU 14 determines that the operation of the forward-reverse selector switch 17 is a consecutive operation. In addition, if the brake is operated and the time period from the time when the vehicle speed fell below the minimum detectable speed to the time when the forward-reverse selector switch 17 was operated is shorter than one second, the transmission ECU 14 also determines that the operation of the forward-reverse selector switch 17 is a consecutive operation.

If the brake is not being operated and the time period from the time when the vehicle speed fell below the minimum detectable speed to the time when the forward-reverse selector switch 17 was operated is longer than five seconds, the transmission ECU 14 determines that the operation of the forward-reverse selector switch 17 is not a consecutive operation. In addition, if the brake is operated and the time period from the time when the vehicle speed fell below the minimum detectable speed to the time when the forward-reverse selector switch 17 was operated is longer than one second, the transmission ECU 14 also determines that the operation of the forward-reverse selector switch 17 is not a consecutive operation.

If it is determined that the vehicle 1 is running (Yes in step S21) or that the operation of the forward-reverse selector switch 17 is a consecutive operation (Yes in step S22), the transmission ECU 14 outputs the first warning signal (step S23) and terminates the warning determination procedure.

If it is determined that the operation of the forward-reverse selector switch 17 is not a consecutive operation (No in step S22), the transmission ECU 14 terminates the warning determination procedure without outputting the first warning signal.

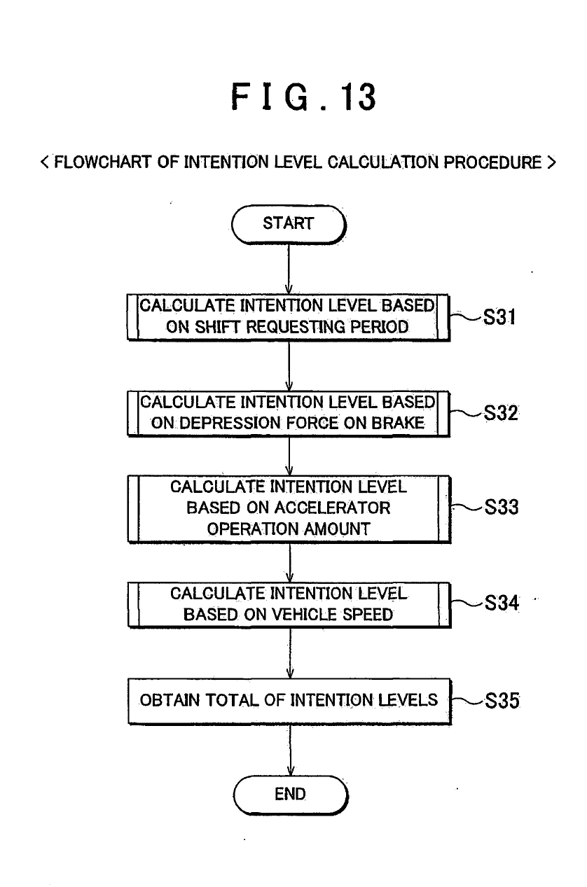

The transmission ECU 14 also performs an intention level calculation procedure in step S13. FIG. 13 is a flowchart for explaining the intention level calculation procedure in the control device for an automatic transmission according to one embodiment of the present invention.

First, the transmission ECU 14 calculates the intention level based on the shift requesting period input from the forward-reverse selector switch 17 (step S31).

In step S31, the transmission ECU 14 acquires the shift requesting period measured by the timer and the information that indicates whether the first warning signal has been output stored in the memory, and calculates the intention level from the first map M1.

The transmission ECU 14 next calculates the intention level based on the depression force applied to the brake pedal (step S32). In step S32, the transmission ECU 14 determines to which of the three levels the depression force applied to the brake pedal belongs based on the brake depression force signal input from the brake depression force sensor 18, calculates the intention level from the second map M2 based on the determined level and the information indicating whether the first warning signal has been output stored in the memory, and stores the calculated intention level in the memory.

The transmission ECU 14 next calculates the intention level based on the accelerator operation amount (step S33). In step S33, the transmission ECU 14 receives the accelerator operation amount signal from the accelerator operation amount sensor 23, determines to which of the three levels the accelerator operation amount indicated by the accelerator operation amount signal belongs, calculates the intention level from the third map M3 based on the determined level and the information indicating whether the first warning signal has been output stored in the memory, and stores the calculated intention level in the memory.

Next, the transmission ECU 14 calculates the intention level based on the vehicle speed (step S34). In step S34, the transmission ECU 14 determines to which of the three levels the vehicle speed indicated by the signal input from the vehicle speed sensor 24 belongs, calculates the intention level from the fourth map M4 based on the determined level and the information indicating whether the first warning signal has been output stored in the memory, and stores the calculated intention level in the memory.

The transmission ECU 14 then obtains the total of the intention levels stored in the memory in step S31 to step S34, and calculates to which of the nine standardized intention levels it belongs (step S35). The transmission ECU 14 stores the calculated intention level in the memory, and terminates the intention level calculation procedure.

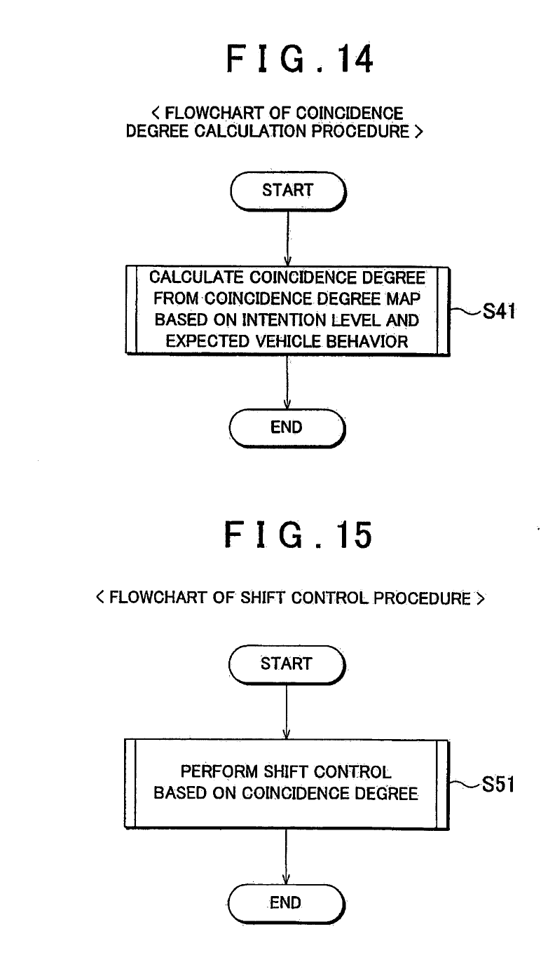

The transmission ECU 14 also performs a coincidence degree calculation procedure in step S14 and calculates the coincidence degree from the coincidence degree map based on the intention level and the expected vehicle behavior (step S41). FIG. 14 is a flowchart for explaining the coincidence degree calculation procedure in the control device for an automatic transmission according to one embodiment of the present invention.

In this step, the transmission ECU 14 acquires the running conditions of the vehicle 1 by receiving the vehicle speed signal from the vehicle speed sensor 24 and calculating the acceleration of the vehicle 1 in the direction of travel from the change in the vehicle speed signal with time.

Next, the transmission ECU 14 calculates the degree of a shift shock which is expected to occur when shifting between forward and reverse modes is actually carried out based on the acquired running conditions and a map (not shown) stored in the ROM as an expected vehicle behavior.

The transmission ECU 14 next calculates the coincidence degree from the coincidence degree map M5 based on the calculated intention level and the expected vehicle behavior, stores the calculated coincidence degree in the memory, and terminates the coincidence degree calculation procedure.

The transmission ECU 14 performs a shift control procedure in step S15. FIG. 15 is a flowchart for explaining the shift control procedure in the control device for an automatic transmission according to one embodiment of the present invention.

First, the transmission ECU 14 acquires the coincidence degree stored in the memory. Then, the transmission ECU 14 performs a gear shift control function on the automatic transmission 5 based on the acquired coincidence degree according to the execution correspondence map M6 (step S51).

Here, if the acquired coincidence degree is “OK,” the transmission ECU 14 outputs the second warning signal to at least one of the monitor 19, the buzzer 20 and the vibration element 21 to warn the driver that a shift shock will occur. Also, the transmission ECU 14 control the automatic transmission 5 via the hydraulic control circuit 9 to shift the automatic transmission 5 between forward and reverse gears, and terminates the shift control procedure.

If the acquired coincidence degree is “NG1,” the transmission ECU 14 controls the automatic transmission 5 via the hydraulic control circuit 9 to shift the automatic transmission 5 to neutral without outputting the second warning signal, and terminates the shift control procedure.

If the acquired coincidence degree is “NG2,” the transmission ECU 14 does not permit the shift the automatic transmission 5 between forward and reverse gears without outputting the second warning signal, and terminates the shift control procedure.

In the control device for an automatic transmission according to this embodiment constituted as described above, the transmission ECU 14 determines whether to permit shifting from one of forward or reverse gear to the other of forward or reverse gear based on the running conditions and operating conditions of the vehicle 1. Therefore, quick shifting reflecting the intention of the driver of the vehicle 1 may be accomplished, and damage to the automatic transmission 5 caused by unusual forward-reverse shifting is thereby prevented. Although a vehicle provided with a shift lever has an interlock mechanism that does not allow the shift lever to be moved into the reverse range unless the push button to move the shift lever into the reverse range is pressed, it is structurally difficult to provide an interlock mechanism to the forward-reverse selector switch of a vehicle without a shift lever. In the control device for an automatic transmission of the present invention, however, it is determined whether to execute a shift control function based on the level of the driver's intention to execute the shift between forward and reverse modes. Therefor, even if the driver accidentally presses the forward-reverse selector switch, a shift between forward and reverse modes is not carried out, which prevents damage to the automatic transmission 5.

In addition, the transmission ECU 14 may acquire the shift requesting period, the depression force applied to the brake pedal and the accelerator operation amount, which change depending on the intention of the driver, as operating conditions. Therefore, the intention of the driver can be reflected in determining whether to permit a gear shift.

Also, because the transmission ECU 14 may determine not to permit shifting from one of the forward or reverse gear to the other of forward or reverse gear to prevent damage to the automatic transmission 5, and because the transmission ECU 14 performs a control function either to shift the automatic transmission 5 to the neutral gear or not to shift the automatic transmission 5 from one of the forward or reverse gear to the other of forward or reverse gear based on the operating conditions, the intention of the driver may be reflected as long as the automatic transmission 5 is not damaged.

In addition, because the transmission ECU 14 determines whether to permit a gear shift based on the speed of the vehicle 1, damage to the automatic transmission 5 caused by abrupt changes in running conditions as a result of a gear shift are reduced.

Also, because the transmission ECU 14 determines whether to permit a gear shift based on the acceleration of the vehicle 1, damage to the automatic transmission 5 caused by abrupt changes in running conditions as a result of a gear shift are reduced.

Also, because the transmission ECU 14 may determine whether the vehicle 1 is running when a request for a shift between forward and reverse gears is made, it is possible to warn the driver that a shift shock will occur if shifting between forward and reverse modes is carried out when the vehicle 1 is running.

Also, because the transmission ECU 14 may determine that the vehicle 1 has not come to a complete stop even if the vehicle speed is below the minimum detectable speed when the time period for which the vehicle speed is below the minimum detectable speed is short, it is possible to warn the driver that a shift shock will occur if a shift between forward and reverse modes is carried out.

While a case in which the transmission mechanism 4 has five forward gears at a maximum is described in this embodiment, the present invention is not limited thereto. The transmission mechanism 4 has four of less or six or more forward gears.

While a case in which the automatic transmission 5 includes a main transmission is described in this embodiment, the automatic transmission 5 may include a main transmission and an auxiliary transmission.

While a case in which the running conditions of the vehicle 1 are classified into five categories and the intention level is classified into nine categories is described in this embodiment, the number of the categories may be more or less than those described herein.

While a case in which an operating condition is classified into three categories in each of the first map M1 to the fourth map M4 is described in this embodiment, the present invention is not limited thereto. The operating condition may be classified into two categories or four or more categories.

As has been described above, the control device for an automatic transmission according to the present invention has an effect that a control function to shift a vehicle between forward and reverse modes can be performed based on the intention level of the driver, and is useful, in particular, to control an automatic transmission in which shifting between forward and reverse gears is made by a forward-reverse selector switch.

While the invention has been described with reference to example embodiments thereof, it is to be understood that the invention is not limited to the described embodiments or constructions. To the contrary, the invention is intended to cover various modifications and equivalent arrangements. In addition, while the various elements of the example embodiments are shown in various combinations and configurations, other combinations and configurations, including more, less or only a single element, are also within the spirit and scope of the invention.

What is claimed is:

1. A control device for an automatic transmission for controlling an automatic transmission provided on a vehicle to shift the automatic transmission between forward, reverse and neutral gears, comprising:
a shift request detection device that detects a shift request from one of the forward or reverse gear to the other of the forward or reverse gear;
an operating condition acquisition device for acquiring an operating condition relating to a shift from one of the forward or reverse gear to the other of the forward or reverse gear;
a running condition acquisition device for acquiring a running condition from a vehicle speed sensor of the vehicle;
a shift determination device that determines whether a gear shift is permissible based on the acquired operating condition and the acquired running condition when a shift request is detected by the shift request detection device; and
a controller that executes a control to shift from one of the forward or reverse gear to the other of the forward or reverse gear when the shift determination device determines that a gear shift is permissible.

2. The control device for an automatic transmission according to claim 1,
wherein the operating condition is indicated by the length of a shift requesting period detected by the shift request detection device.

3. The control device for an automatic transmission according to claim 2,
wherein the operating condition is indicated by a depression force applied to a brake pedal of the vehicle.

4. The control device for an automatic transmission according to claim 3,
wherein the operating condition is indicated by an operation amount of an accelerator of the vehicle.

5. The control device for an automatic transmission according to claim 4,
wherein the operating condition acquisition device acquires the length of a shift requesting period detected by the shift request detection device, a depression force applied to the brake pedal, an operation amount of the accelerator, and the speed of the vehicle comprehensively as the operating condition.

6. The control device for an automatic transmission according to claim 1,
wherein the operating condition is indicated by a depression force applied to a brake pedal of the vehicle.

7. The control device for an automatic transmission according to claim 1,
wherein the operating condition is indicated by an operation amount of an accelerator of the vehicle.

8. The control device for an automatic transmission according to claim 1,
wherein the controller executes a control either to shift to the neutral gear or to prevent a shift from one of the forward or reverse gear to the other of the forward or reverse gear when the shift determination device determines that a gear shift is not permissible.

9. The control device for an automatic transmission according to claim 1,
wherein the running condition is indicated by a speed of the vehicle acquired by the running condition acquisition device.

10. The control device for an automatic transmission according to claim 1,
wherein the running condition is indicated by an acceleration calculated from the acquired speed of the vehicle.

11. The control device for an automatic transmission according to claim 1,
further comprising: a limit speed determination device that determines whether the speed of the vehicle is equal to or above a minimum detectable speed that indicates the minimum speed that can be acquired by the running condition acquisition device when the shift request detection device detects a shift request,
wherein the controller controls a warning device mounted on the vehicle to provide a warning before the shift from one of the forward or reverse gear to the other of the forward or reverse gear is accomplished if the limit speed determination device determines that the speed of the vehicle is equal to or above the minimum detectable speed.

12. The control device for an automatic transmission according to claim 11,
wherein the controller controls the warning device mounted on the vehicle to provide the warning based on whether the brake is operated and the time period for which the vehicle is at a speed below the minimum detectable speed when the limit speed determination device determines that the speed of the vehicle is below the minimum detectable speed.

13. A control method for an automatic transmission for controlling an automatic transmission provided on a vehicle to shift the automatic transmission between forward, reverse and neutral gears, comprising:
detecting a shift request from one of the forward or reverse gear to the other of the forward or reverse gear;
acquiring an operating condition relating to a shift from one of the forward or reverse gear to the other of the forward or reverse gear;
acquiring a running condition from a vehicle speed sensor;
determining whether a gear shift is permissible based on the operating condition and the running condition when the shift request is detected; and
executing a control to shift from one of the forward or reverse gear to the other of the forward or reverse gear when it is determined that a gear shift is permissible.

14. The control method for an automatic transmission according to claim 13,
wherein the operating condition is indicated by the length of a shift requesting period.

15. The control method for an automatic transmission according to claim 13,
wherein the operating condition is indicated by a depression force applied to a brake pedal of the vehicle.

16. The control method for an automatic transmission according to claim 13,
wherein the operating condition is indicated by an operation amount of ah accelerator of the vehicle.

17. The control method for an automatic transmission according to claim 13,
wherein the length of a shift requesting period, a depression force applied to a brake pedal of the vehicle, an operation amount of an accelerator of the vehicle, and the speed of the vehicle are acquired comprehensively as the operating condition.

18. The control method for an automatic transmission according to claim 13, further comprising:
executing a control either to shift to the neutral gear or to prevent a shift from one of the forward or reverse gear to the other of the forward or reverse gear When it is determined that a gear shift is not permissible.

19. The control method for an automatic transmission according to claim 13,
wherein the running condition is indicated by the acquired speed of the vehicle.

20. The control method for an automatic transmission according to claim 13,
wherein the running condition is indicated by an acceleration calculated from the speed of the vehicle.

21. The control method for an automatic transmission according to claim 13, further comprising:
determining whether the speed of the vehicle is equal to or above a minimum detectable speed that indicates the minimum speed that can be acquired when a shift request is detected; and
controlling a warning device mounted on the vehicle to provide a warning before a shift from one of the forward or reverse gear to the other of the forward or reverse gear is accomplished if it is determined that the speed of the vehicle is equal to or above the minimum detectable speed.

22. The control method for an automatic transmission according to claim 21, further comprising:
controlling the warning device mounted on the vehicle to provide the warning based on whether the brake is operated and the time period for which the vehicle is at a speed equal to or below the minimum detectable speed when it is determined that the speed of the vehicle is below the minimum detectable speed.
